(19) United States
(12) Patent Application Publication
(10) Pub. No.: US 2017/0113290 A1
(43) Pub. Date: Apr. 27, 2017

(54) Brazing Process of Pipes and Compressor

(71) Applicant: Whirlpool S.A., Sao Paulo (BR)

(72) Inventor: Moises Alves De Oliveira, Joinville (BR)

(73) Assignee: Whirlpool S.A.

(21) Appl. No.: 15/297,311

(22) Filed: Oct. 19, 2016

(30) Foreign Application Priority Data
Oct. 22, 2015 (BR) 10 2015 026864 5

(51) Int. Cl. B23K 1/00; B23K 35/28; C22C 18/04; B23K 1/19

(52) U.S. Cl. CPC B23K 1/0008; B23K 1/19; B23K 35/282; C22C 18/04; B23K 2201/06

(57) ABSTRACT

The present invention describes a brazing process in copper and steel parts for several equipment, using a zinc alloy as an additive material, and a device produced according do said process. Specifically, the present invention includes a brazing process between a copper pipe and a steel part, using an alloy composed mainly by zinc as addiction material. Said brazing process is applied to exhaust copper pipes and steel exhaust system, both present in the compressors. The present invention is situated on the industrial field of compressors, metallurgy, mechanical engineering and materials engineering.

### FIELD OF THE INVENTION

The present invention describes a brazing process for joining parts of equipment, more specifically brazing of an exhaust pipe of a compressor and a compressor comprising a brazed exhaust system. The present invention lies in the fields of compressor industry, metallurgy, mechanical engineering and materials engineering.

### BACKGROUND OF THE INVENTION

Brazing is a process that uses the filler of a heated metal to or beyond its melting point, and characterized in that the filler of the molten metal being different of base metals, and may be a pure metal or a metallic specific alloy. As the melting point of the filler materials is generally low, the brazing can be made using fuel gas mixtures of atmospheric air and low heat transfer. These devices are known as air-gas type and are usually used in service in pipes and refrigeration equipment. Brazing uses a filler rod that generally melts at temperatures above 450° C. and may vary with the alloy. The base metals to be joined can be of different natures. The brazing process can use air-fuel flame or oxyfuel, and heating by induction.

While the oxy-acetylene flame is always necessary for the welding flame (melting material), the brazing can be performed by other combustible gases such as propane, natural gas, propylene, etc. This is because the brazing process, there is the filler of a flux function with pre-cleaning and deoxidation similar to the oxy-acetylene flame.

Brazing differs from the oxywelding in melting temperature of metal added and the base material to be joined, and occurs at temperatures below the melting point of the base metal, but at temperatures at or above the melting point of the filler material to fill the joints to which they are intended.

The particularity of the process is in the capillarity action resultant from the interaction of the material to be added, from the joint or parts to be joined dimensions, the base material and the brazing temperature. The steel parts or other material to be welded do not need to be melt for being joint satisfactorily. The use of brazing allows mechanical fixing, liquid and gases sealing, and in many cases, pipes joint and geometrically compatible parts.

The advantages presented in can be brazed processes: the use of lower temperatures cause lower warpage of the part; or unwanted change of the base material microstructure. Base materials of different natures (ferrous and nonferrous) can be brazed and steel parts to be brazed not need to be merged to promote unity.

Currently in some applications in which brazing is used, it is common use to use silver or silver alloy as filler material, which ensures good strength, compatibility and finish to certain groups of base materials. However, the use of silver or alloys thereof, becomes a process of high cost due to the market price of silver itself, which is historically a noble and valued metal.

Routinely, the brazing process with silver alloys has been practiced by the fact that ensures good adhesion and compatibility in joining application of steel and copper, as well as promoting durable mechanical joint, prevents the leading cause of leaks in sealed systems (for example, compressors): porosity. Another major beneficial factor in the use of silver alloy is the fact that it can be free of cadmium, and thus understand systems that are in constant contact with humans. The current industry does not have enough knowledge to replace the silver and its alloys in a satisfactory manner, that is, to prepare a union process of copper tubes in steel parts that is efficient, and physically and chemically feasible.

Thus, what is clear from the literature, no documents were found suggesting or anticipating the teachings of the present invention, so that the solution proposed here has novelty and inventive activity against the state of the art.

### SUMMARY OF THE INVENTION

Thus, the present invention aims to solve the listed problems in state of the art from the use of an alloy of zinc and aluminum which when heated and placed under specific conditions, replace the silver and their alloys as material added in brazing processes. The final mechanical characteristics obtained are similar to those generated from the brazing using silver and its alloys, but the costs are significantly reduced.

In a first embodiment, the present invention provides a brazing process of copper pipe on steel parts from an alloy composed mainly of zinc.

In a second embodiment of the present invention, a compressor comprising copper exhaust pipe is fixed to a steel structure via specific brazing process with alloys composed mainly of zinc.

From the specific heating with temperature, atmosphere and heating time controlled, the connection between the exhaust pipe of a compressor and the exhaust system can be promoted through the brazing process exemplified by the present invention.

Brazing of the present invention comprises adding a zinc-aluminum alloy so that the process is carried out at lower temperatures, which minimizes the size of the area affected by the heat from the base materials, besides reducing the consumption of energy required for heating, thereby reducing the cost of the material involved.

These and other objects of the invention will be immediately appreciated by those versed in the art and by companies with interests in the sector, and will be described in sufficient detail to reproduce in the description below.

### BRIEF DESCRIPTION OF THE DRAWINGS

In order to better define and clarify the content of the present application, the following figure appears:

FIG. 1 shows a copper tube (C) added/attached to a metal part of steel (A) after being subjected to brazing with a zinc alloy (Z).

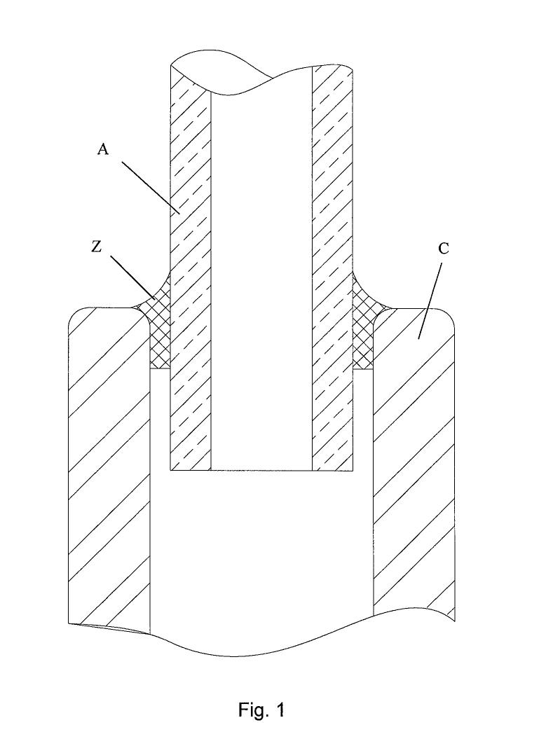

### DETAILED DESCRIPTION OF THE INVENTION

The descriptions that follow are presented by way of example and not limiting the scope of the invention and will understand more clearly the object of the present application.

The present invention has the objective to present a solution for the production of compressors, in particular by a brazing process that replaces the conventional use of silver and their alloys, for an alloy mainly composed of zinc as filler material for hermetic connection pieces made of different metals.

The capillary or capillary action is the ability of a liquid metal has to fill spaces between the components to braze. In the brazing process it is not necessary to work the profile parts, because these do not fuse. What will join the pieces is the filler of metal. This cast do penetrate the spaces between the parts to braze.

The brazing with silver alloys presents a better capillarity than zinc alloy, which can be related to the temperature (high to silver alloys) and different properties of the two filler materials, such as: density, thermal conductivity, surface tension, among others. This implies that the filler of metal composed of zinc may have lower penetration rates.

However, for the proposed application in the present invention, the smallest capillarity of zinc alloys is still sufficient to fulfill the mechanical strength requirements, and which is offset by reduced costs with the acquisition of material.

The present invention contemplates the use of a zinc and aluminum alloy as filler material for a brazing process carried out at low temperatures at which the fusion of the filler material can be controlled, which minimizes the size of the affected area heat between the base material and reduce the energy consumption required for heating, thereby reducing the cost of the material involved.

### Example 1

### Preferred Realization

In a first object the present invention provides a copper pipe brazing process of steel parts from an alloy mainly comprising zinc, or the alloy used as the filler material consists of 98% of zinc and 2% aluminum.

### Example 2

### Preferred Realization

In a second object of the present invention, a compressor comprising copper discharge pipe is fixed to a steel structure, the type Bundy tube, through the specific brazing process with alloys composed mainly of zinc.

Those skilled in the art will value the knowledge presented herein, and may play the invention shown in the embodiments, and other embodiments which fall within the scope of the appended claims.

1. Brazing process of pipes wherein a first pipe is composed of copper and a second pipe is composed of steel, the process characterized by comprising:
applying, between said first and second pipes, a brazing alloy composed by Zinc/Aluminum; and
application of controlled means of melting and cooling of the first set and second tubes and braze alloy.

2. Process, according to claim 1, characterized by the fact that brazing alloy comprises between 95%-99% of Zinc and 5%-1% of Aluminum.

3. Process, according to claim 1, characterized by the fact that the brazing alloy comprises 98% of Zinc and 2% of Aluminum.

4. Compressor comprising exhaust system composed by a first pipe composed of copper and a second pipe composed by steel, characterized by being brazed by a process as defined in claim 1.
